(19) United States
(12) Patent Application Publication
(10) Pub. No.: US 2017/0161750 A1
(43) Pub. Date: Jun. 8, 2017

(54) Identity Authentication Method, Terminal Device And System

(71) Applicant: Tencent Technology (Shenzhen) Company Limited, Shenzhen (CN)

(72) Inventors: Longyang YAO, Shenzhen (CN); Zhangqun FAN, Shenzhen (CN); Wen OUYANG, Shenzhen (CN); Runqian ZHAO, Shenzhen (CN)

(73) Assignee: Tencent Technology (Shenzhen) Company Limited, Shenzhen (CN)

(21) Appl. No.: 15/431,238

(22) Filed: Feb. 13, 2017

Related U.S. Application Data
(63) Continuation of application No. PCT/CN2015/088131, filed on Aug. 26, 2015.

(30) Foreign Application Priority Data
Aug. 26, 2014 (CN) 201410425691.X

(51) Int. Cl. G06Q 20/40; G06K 7/14

(52) U.S. Cl. CPC G06Q 20/40145; G06K 7/1417; G06K 9/00288

(57) ABSTRACT

An identity authentication method, terminal device and system are provided. A terminal device scans a two-dimensional code after receiving a two-dimensional code scanning instruction. After receiving the two-dimensional code scanning instruction, the terminal device automatically opens a biometric information acquisition function, and acquires the biometric information of a user currently operating the terminal device. Identity authentication is performed on the biometric information, to determine whether the user has an operation authority corresponding to the two-dimensional code.

### CROSS REFERENCE TO RELATED APPLICATION

This application is a Continuation of International Application PCT/CN2015/088131, titled “IDENTITY AUTHENTICATION METHOD, TERMINAL DEVICE AND SYSTEM”, and filed on Aug. 26, 2015, which claims priority to Chinese Patent Application No. 201410425691.X, titled “IDENTITY AUTHENTICATION METHOD, TERMINAL DEVICE AND SYSTEM”, filed on Aug. 26, 2014 with the State Intellectual Property Office of the People's Republic of China, both of which are incorporated herein by reference in their entirety.

### TECHNICAL FIELD

The present disclosure relates to the field of computer technology, and in particular to a method, a terminal device and a system for identity authentication.

### BACKGROUND

Identity authentication is a process of confirming the identity of an operator in a computer network. Information in a computer network, including identity information of a user, is expressed as a set of specific numbers. Computers can only identify digital identities of users, and all authorization of users is authorization of digital identities of the users. The identity authentication technology is to solve the problem of how to ensure that an operator operating with a digital identity is a valid owner of the digital identity, i.e., how to ensure that a physical identity of the operator corresponds to the digital identity. As a first pass for protecting network asserts, identity authentication plays a vital role.

Two-dimensional code payment on a WeChat platform on a mobile terminal is taken as an example. The payment process includes: for a web code scanning payment or an offline code scanning payment, opening a two-dimensional code payment function of WeChat on the mobile terminal, scanning a generated two-dimensional commodity transaction code, and inputting a payment password to perform identity authentication and payment confirmation, thus completing the payment.

An underlying support for the above process includes associating a mobile client with a bank card account, which specifically includes: associating the mobile client with the bank card account in advance, a merchant client generating a two-dimensional transaction code, the mobile client reading the two-dimensional transaction code and processing the read two-dimensional transaction code and an inputted transaction voucher to generate a transaction message and transmit the transaction message to a payment platform, and finally, the payment platform processing the transaction message and forwarding the transaction message to a bank transaction system to complete the transaction.

In the above method for two-dimensional code payment, the two-dimensional code needs to be scanned, and a user needs to input the payment password to perform authentication. Therefore, multiple operation steps need to be performed, and the efficiency of identity authentication is low.

### SUMMARY

A method, a terminal device and a system for identity authentication are provided according to embodiments of the present disclosure, to reduce operation steps of identity authentication and improve the efficiency of identity authentication.

A method for identity authentication is provided, which includes:

scanning by a terminal device a two-dimensional code, after receiving a two-dimensional code scanning instruction;

opening by the terminal device a biometric information acquisition function automatically to acquire biometric information of a user being operating the terminal device, after receiving the two-dimensional code scanning instruction; and

performing identity authentication on the biometric information to determine whether the user has an operation authority corresponding to the two-dimensional code.

A terminal device is provided, which includes:

a processor;

a memory; and

program units stored in the memory to be executed by the processor, where the program units include:

an instruction receiving unit, configured to receive a two-dimensional code scanning instruction;

a scanning unit, configured to scan a two-dimensional code, after the two-dimension scanning instruction is received by the instruction receiving unit;

a biometric acquisition unit, configured to open a biometric information acquisition function automatically to acquire biometric information of a user being operating the terminal device, after the two-dimensional code scanning instruction is received by the instruction receiving unit; and

an authentication unit, configured to perform identity authentication on the biometric information to determine whether the user has an operation authority corresponding to the two-dimensional code.

A system for identity authentication is provided, which includes: a terminal device and a server which are communicatively connected with each other;

where the terminal device is a terminal device according to the embodiments of the present disclosure, and the terminal device transmits a two-dimensional code and biometric information to the server; and

where the server is configured to perform identity authentication on the biometric information to determine whether a user has an operation authority corresponding to the two-dimensional code.

In the above technical solutions, the terminal device executes the two-dimensional code scanning instruction to obtain the two-dimensional code after receiving the two-dimensional code scanning instruction; the two-dimensional code may include various operating instructions and may require authentication; in this case, the terminal device opens the biometric information acquisition function automatically to acquire the biometric information of the user currently being operating the terminal device, that is, the terminal device may automatically obtain information which can be used to authenticate user identity. In this way, a step of inputting information such as a verification code or a password is saved for the user. Therefore, a one-touch operation can be achieved, which simplify operation of identity authentication and improves the efficiency of identity authentication.

### BRIEF DESCRIPTION OF THE DRAWINGS

In order to more clearly illustrate technical solutions in embodiments of the present disclosure, drawings used in the description of the embodiments are introduced briefly hereinafter. Apparently, the drawings described hereinafter only illustrate some embodiments of the present disclosure, and other drawings may be obtained by those skilled in the art based on these drawings without any creative efforts.

FIG. 1 is a schematic flow chart of a method according to an embodiment of the present disclosure;

FIG. 2A is a schematic diagram of an application scenario according to an embodiment of the present disclosure;

FIG. 2B is a schematic diagram of an application scenario according to another embodiment of the present disclosure;

FIG. 3 is a schematic flow chart of face binding according to an embodiment of the present disclosure;

FIG. 4 is a schematic flow chart of identity authentication according to an embodiment of the present disclosure;

FIG. 5 is a schematic flow chart of face image pre-processing according to an embodiment of the present disclosure;

FIG. 6 is a schematic flow chart of face sample space training according to an embodiment of the present disclosure;

FIG. 7 is a schematic diagram of face recognition according to an embodiment of the present disclosure;

FIG. 8 is a schematic flow chart of two-dimensional code detection according to an embodiment of the present disclosure;

FIG. 9 is a schematic flow chart of two-dimensional code recognition according to an embodiment of the present disclosure;

FIG. 10 is a schematic structural diagram of a terminal device according to an embodiment of the present disclosure;

FIG. 11 is a schematic structural diagram of a terminal device according to another embodiment of the present disclosure;

FIG. 12 is a schematic structural diagram of a terminal device according to still another embodiment of the present disclosure;

FIG. 13 is a schematic structural diagram of a system according to an embodiment of the present disclosure;

FIG. 14 is a schematic structural diagram of a terminal device according to still another embodiment of the present disclosure; and

FIG. 15 is a schematic structural diagram of a terminal device according to still another embodiment of the present disclosure.

### DETAILED DESCRIPTION OF THE EMBODIMENTS

In order to make the object, the technical solutions, and the advantages of the present disclosure clearer, the present disclosure is further described in detail hereinafter in conjunction with the drawings. Apparently, the described embodiments are only a few but not all of embodiments of the present invention. All other embodiments obtained by those ordinarily skilled in the art based on the embodiments of the present disclosure without any creative efforts fall within the protection scope of the present disclosure.

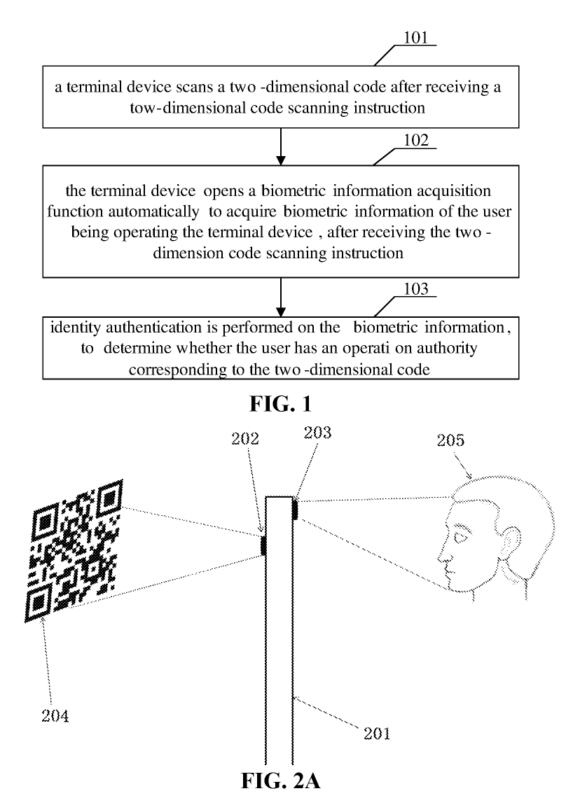

A method for identity authentication is provided according to an embodiment of the present disclosure. As shown in FIG. 1, the method includes steps 101 to 103.

In step 101, a terminal device scans a two-dimensional code after receiving a tow-dimensional code scanning instruction.

In the embodiment of the present disclosure, the two-dimensional code scanning instruction refers to a trigger condition for triggering the execution of two-dimensional code scanning, which is input by a user. For example, when using an application in the terminal device, if it is required to perform two-dimensional code scanning, the user may input a two-dimensional code scanning instruction. The two-dimensional code may be a picture in the terminal device or the two-dimensional code may be printed or displayed on medium other than the terminal device, which is not limited by the embodiments of the present disclosure. If the two-dimensional code is in the terminal device, two-dimensional code scanning may be achieved by scanning software. If the two-dimensional code is printed or displayed on medium other than the terminal device, the two-dimensional code may usually be scanned by using an application to control a rear camera of the terminal device.

In step 102, the terminal device opens a biometric information acquisition function automatically to acquire biometric information of the user being operating the terminal device, after receiving the two-dimension code scanning instruction.

In the embodiment of the present disclosure, the biometric information is used to authenticate the identity of the user. Specifically, the biometric information can be used to uniquely identify user identity and may include face, fingerprint, iris, voice and the like, alone or in combination. The biometric information acquisition function is opened automatically and is performed at the same time as the operation of scanning the two-dimensional code, thus the biometric information of the user currently being operating the terminal device can be acquired. That is, information that can be used to authenticate the user identity can be obtained automatically.

In step 103, identity authentication is performed on the biometric information, to determine whether the user has an operation authority corresponding to the two-dimensional code.

In the embodiment of the present disclosure, the terminal device executes the two-dimensional code scanning instruction to obtain the two-dimensional code after receiving the two-dimensional code scanning instruction; the two-dimensional code may include various operating instructions and may require authentication; in this case, the terminal device opens the biometric information acquisition function automatically to acquire the biometric information of the user currently being operating the terminal device, that is, the terminal device may automatically obtain information which can be used to authenticate user identity. In this way, a step of inputting information such as a verification code or a password is saved for the user. Therefore, a one-touch operation can be achieved, which simplify operation of identity authentication and improves the efficiency of identity authentication. In addition, since user identity authentication is performed by acquiring the biometric information of the user currently being operating the terminal device, the security of identity authentication is improved.

Optionally, in the embodiment of the present disclosure, the step of identity authentication may be locally completed in the terminal device directly. Or, the terminal device may be used as an acquisition device for information, and the step of identity authentication is completed at a side of a server. In a case that identity authentication is completed by the server, an identity authentication result may be fed back to the terminal device; or the identity authentication result is not fed back to the terminal device, and an operation result is returned to the terminal device after an operating instruction corresponding to the two-dimensional code is executed. Operations to be performed after an authentication result is determined may be arbitrarily set based on specific application scenarios and needs, which are not limited by the embodiments of the present disclosure. Specifically, performing identity authentication on the biometric information to determine whether the user has an operation authority corresponding to the two-dimensional code includes:

in a case that identity authentication is to be locally completed in the terminal device, performing identity authentication on the biometric information based on locally stored biometric information, to determine whether the user has the operation authority corresponding to the two-dimensional code; or, in a case that identity authentication is to be completed at the side of the server, transmitting the two-dimensional code obtained by scanning and the biometric information to the server, to enable the server to perform identity authentication on the biometric information to determine whether the user has the operation authority corresponding to the two-dimensional code.

It may be unsuccessful in scanning the two-dimensional code, and it may be unsuccessful in acquiring the biometric information, too. It can be understood that prompting is needed when it is unsuccessful in scanning the two-dimensional code. The step of acquiring the biometric information does not require the user to execute the two-dimensional code scanning instruction. In practice, since the biometric information needs to be used to perform identity authentication, prompting is also needed when it is unsuccessful in acquiring the biometric information. And the information needs to be acquired for the next time. Specifically, if it is unsuccessful in scanning the two-dimensional code, or it is unsuccessful in acquiring the biometric information of the user currently operating the terminal device, then the above method further includes: prompting that information is acquired unsuccessfully, and prompting that two-dimensional code information and the biometric information need to be re-acquired.

The two-dimensional code information and the biometric information need to be transmitted over network, the biometric information relates to privacy information of the user, and hence high security is needed. In order to improve information security, the two-dimensional code information and the biometric information may be encrypted according to the embodiment of the present disclosure. Specifically, before transmitting the two-dimensional code obtained by scanning and the biometric information to the server, the method further includes:

packaging the two-dimensional code obtained by scanning and the biometric information into an encrypted message.

There are multiple types of biometric information that can be used to identify user identity, and implementations of the embodiments of the present disclosure will not be affected by the selection. At present, face recognition technology, iris recognition technology and fingerprint recognition technology are commonly used and have low cost. These technology can be implemented based on the current available hardware devices, and can be used as preferred implementation solutions of the embodiment of the present disclosure, which are specifically described as follows.

If the biometric information includes: face image information or iris information, opening a biometric information acquisition function automatically to acquire biometric information of the user being operating the terminal device includes: while scanning the two-dimensional code, turning on a front camera of the terminal device automatically to obtain face image information or iris information in front of the terminal device.

The above embodiment may be applied to a terminal including a front camera, such as a mobile phone including a front camera and a rear camera. The front camera captures a face image at the same time as the rear camera captures a two-dimensional code, which is very convenient and efficient.

If the biometric information includes fingerprint information, opening a biometric information acquisition function automatically to acquire biometric information of the user being operating the terminal device includes: turning on a fingerprint sensor automatically, to capture a fingerprint at an interface button for inputting the two-dimensional code scanning instruction.

Some terminal devices have a fingerprint recognition function and also include a fingerprint sensor for capturing fingerprint information. For example, for an attendance device, a fingerprint may be captured at a button where the user inputs a two-dimensional code scanning instruction. In this way, a one-touch operation can also be achieved, which is very convenient and efficient.

In the following embodiments, a mobile terminal including a front camera and a rear camera is taken as an example to illustrate various parts related to the embodiments of the present disclosure.

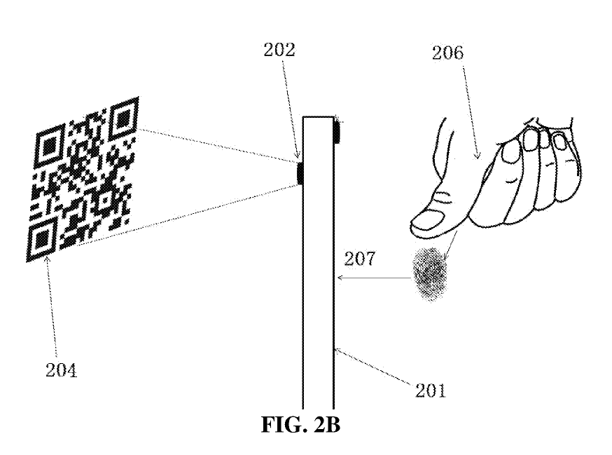

Reference is made to FIG. 2A, which is a schematic diagram of an application scenario according to an embodiment of the present disclosure, including: a mobile terminal 201 including a front camera 203 and a rear camera 202, a user 205 located at a side of the front camera 203 of the mobile terminal 201 and a two-dimensional code 204 located at a side of the rear camera 202.

When the user 205 operates the mobile terminal 201 to perform two-dimensional code scanning, the front camera 203 may scan the user 205 currently being operating the mobile terminal 201 at the same time as the rear camera 202 scans the two-dimensional code 204.

It can be seen from FIG. 2A that: two-dimensional code information and face image information which is sampled from face data of the user may be synchronously bound by scanning the two-dimensional code and the face of the user with the mobile terminal including both the front camera and the rear camera, which enhances the security of identity authentication, improves user experience in terms of performing identity authentication and information confirmation on a mobile platform and further improves the convenience in application fields of mobile payment, user login, etc. In addition, the rear camera obtains a two-dimensional code image, the front camera obtains the face image, and the mobile terminal packages and then transmits characteristic data extracted from the two-dimensional code image and the face image to the server to perform synchronous information processing and identity authentication. Different function may be achieved based on application results in different application scenarios. The specific functions are not limited by the embodiments of the present disclosure.

Reference is made to FIG. 2B, which is a schematic diagram of another application scenario according to an embodiment of the present disclosure. Compared with FIG. 2A, the manner of acquiring biological information at a side of the user is different. In FIG. 2B, at the side of the user, a finger 206 of the user has a fingerprint, and the fingerprint of the finger 206 will be obtained by a fingerprint sensor 207 when the finger touches the fingerprint sensor 207 on a screen of the mobile terminal 201.

It can be seen from FIG. 2B that, two-dimensional code information and fingerprint information of the user may be synchronously bound by scanning the two-dimensional code and obtaining the fingerprint of the finger performing the operation of scanning the two-dimensional code with the mobile terminal including the rear camera and the fingerprint sensor, which enhances the security of identity authentication, improves user experience in terms of performing identity authentication and information confirmation on a mobile platform and further improves the convenience in application fields of mobile payment, user login, etc. In addition, the rear camera obtains a two-dimensional code image, the fingerprint sensor obtains the fingerprint information, and the mobile terminal packages and then transmits characteristic data extracted from the two-dimensional code image and the fingerprint information to the server to perform synchronous information processing and identity authentication. Different function may be achieved based on application results in different application scenarios. The specific functions are not limited by the embodiments of the present disclosure. The fingerprint recognition technology and the face recognition technology belong to the area of digital image recognition. In the following embodiments, face image recognition is taken as an example for illustration. For fingerprint recognition, reference can be made to face image recognition, which is not described herein.

In the following embodiments, various parts related to the embodiments of the present disclosure are described with examples.

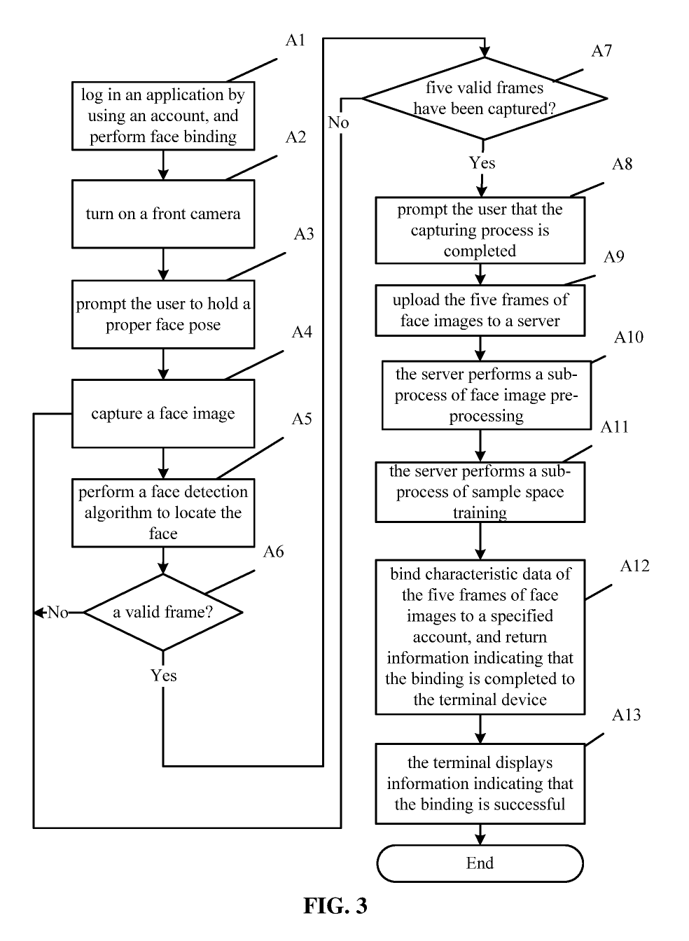

1. Reference is made to FIG. 3, which is a schematic flow chart of face binding and is a process of information processing before identity authentication.

In step A1, a user logs in an application by using an account, and determines whether the account has been bound to a face or whether face binding needs to be set again. In a case that the account has not been bound to a face or face binding needs to be set again, the following process will be performed.

In step A2, a front camera is turned on.

In step A3, the user is prompted to hold a proper face pose.

The above steps A1 to A3 mainly belong to a constraint stage for capturing face image. When the face of the user is photographed, the user needs to exactly face the front camera without a large area of the face being obscured and with no exaggerated facial expression.

In step A4, a face image is captured.

In step A5, a face detection algorithm is performed to locate the face.

In step A6, it is determined whether the captured face image is a valid frame. If the captured face image is a valid frame, the process goes to step A7. Otherwise, the process goes to step A4.

In step A7, it is determined whether five valid frames have been captured. If five valid frames have been captured, the process goes to step A8. Otherwise, the process goes to step A4.

In step A8, the user is prompted that the capturing process is completed.

The above steps A4 to A8 are a face capturing stage. The front camera captures five frames of face images, and each frame needs to be valid. That is, a face can be clearly detected in each frame with the face detection algorithm.

In step A9, the five frames of face images are uploaded to a server.

If identity authentication is to be locally completed in a terminal device, then step A9 may not be performed, and the following steps to be performed by the server will be performed at a side of the terminal device.

In step A10, a sub-process of face image pre-processing is performed by the server.

In step A11, a sub-process of sample space training is performed by the server.

Main functions of the above steps A9 to A11 include: uploading the five frames of face images to the server, and the server performing the sub-process of face image pre-processing and the sub-process of sample space training to subsume the five frames of face images into a characteristic database.

In step A12, characteristic data of the five frames of face images are bound to a specified account, and information indicating that the binding is completed is returned to the terminal device.

In step A13, information indicating that the binding is successful is displayed on the terminal device.

The main function of the above steps A12 to A13 include: binding the characteristic data of the five frames of face images to the account on the server, and prompting the user that the binding is successful.

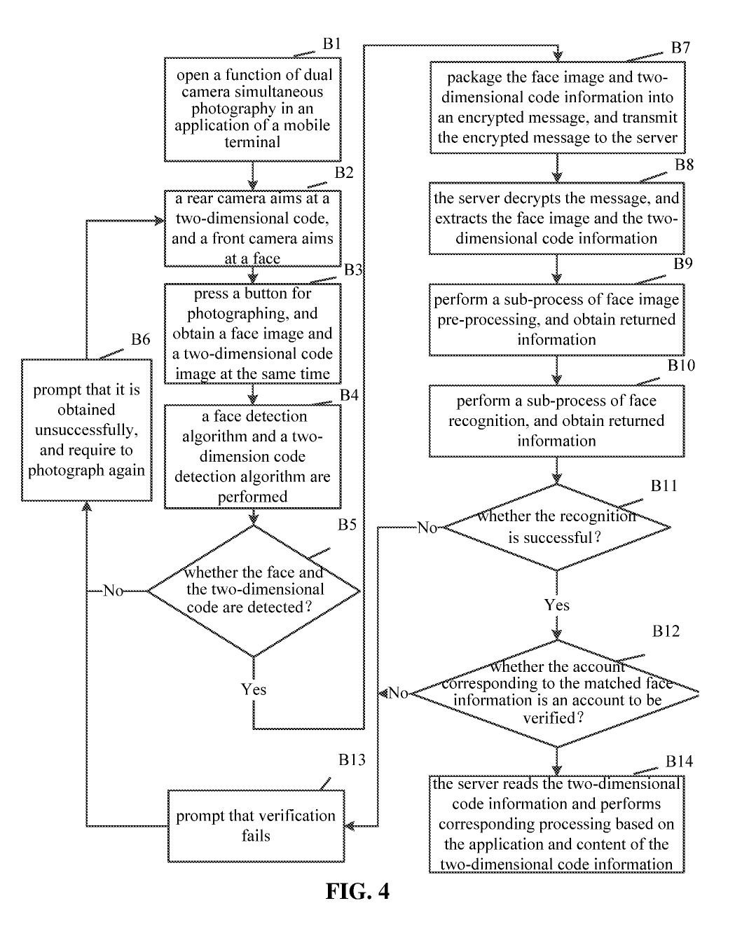

2. Reference is made to FIG. 4, which is a schematic flow chart of identity authentication. The process is specifically described as follows.

In step B1, a function of dual camera simultaneous photography is opened in an application of a mobile terminal.

In step B2, a rear camera aims at a two-dimensional code, and a front camera aims at a face.

In step B3, a button for photographing is pressed, and a face image and a two-dimensional code image are obtained at the same time.

In step B4, a face detection algorithm and a two-dimension code detection algorithm are performed.

In step B5, it is determined whether the face and the two-dimensional code are detected. If the face and the two-dimensional code are detected, the process goes to step B7. Otherwise, the process goes to step B6.

In step B6, it is prompted that information is obtained unsuccessfully, and it is required to photograph again.

The above steps B1 to B6 are a stage of face image acquisition. It is determined whether the current frame is a valid frame based on the face detection algorithm and the two-dimensional code detection algorithm. If the current frame is not a valid frame, the current frame is discarded.

In step B7, the face image and two-dimensional code information are packaged into an encrypted message, and the encrypted message is transmitted to the server.

In step B8, the server decrypts the message, and extracts the face image and the two-dimensional code information.

In step B9, a sub-process of face image pre-processing is performed, and returned information is obtained.

In step B10, a sub-process of face recognition is performed, and returned information is obtained.

In step B11, it is determined whether the recognition is successful. If the recognition is successful, the process goes to step B12. Otherwise, the process goes to step B13.

The above steps B7 to B11 are a stage of data transmission and face recognition: encrypting the two-dimensional code information and face characteristic data with a user key and then transmitting them to the server, the server performing data encryption and information reduction with a user ID, comparing and determining the face characteristic data in the characteristic database, performing identity authentication, returning information indicating that the recognition fails if no face information matching the face characteristic data obtained by means of information reduction can be obtained from the characteristic database, and returning an account corresponding to the matched face information if face information matching the face characteristic data obtained by means of information reduction can be obtained from the characteristic database.

In step B12, it is recognized whether the account corresponding to the matched face information is an account to be verified.

In step B13, it is prompted that verification fails.

The above steps B12 to B13 include: if the face information matching the face characteristic data is obtained, it is determined whether the account corresponding to the matched face information is identical with the account used to log in, and if the account corresponding to the matched face information is not identical with the account used to log in, information indicating that verification fails is prompted.

In step B14, the server reads the two-dimensional code information and performs corresponding processing based on the application and content of the two-dimensional code information.

The above step B14 includes: determining whether face information bound to the account used to log in is identical with the obtained face information matching the face characteristic data, determining that identity authentication is passed if the face information bound to the account used to log in is identical with the obtained face information matching the face characteristic data, and the sever making different responses for different application scenarios based on the two-dimensional code information. For example, for a payment application on a WeChat platform of a mobile terminal, a server processes a payment workflow for commodity purchase. For a login of Web WeChat on a PC (personal computer) terminal, response of the server to login of the WEB page is completed. For an attendance registration application, the server determines checkin information of staff based on two-dimensional code information, determines a person that attends based on an identity authentication result and updates an attendance database.

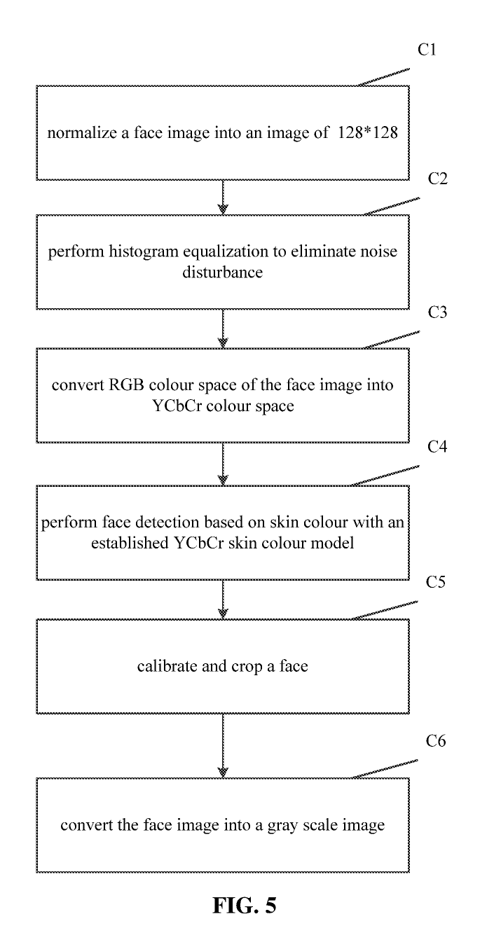

3. Reference is made to FIG. 5, which is a schematic flow chart of face image pre-processing. The process includes the following steps.

In step C1, a face image is normalized into an image of 128*128.

In step C2, histogram equalization is performed to eliminate noise disturbance.

The above steps C1 to C2 are a stage of image pre-processing. The image is normalized and histogram equalization is used to eliminate the noise.

In step C3, RGB colour space of the face image is converted into YCbCr colour space.

In step C4, face detection based on skin colour is performed with an established YCbCr skin colour model.

The above steps C3 to C4 are a stage of face detection. Face detection is performed with the YCbCr skin colour model.

In step C5, a face is calibrated and cropped.

In step C6, the face image is converted into a gray scale image.

The above steps C5 to C6 includes: calibrating and cropping a face part, and converting the colour image into the gray scale image.

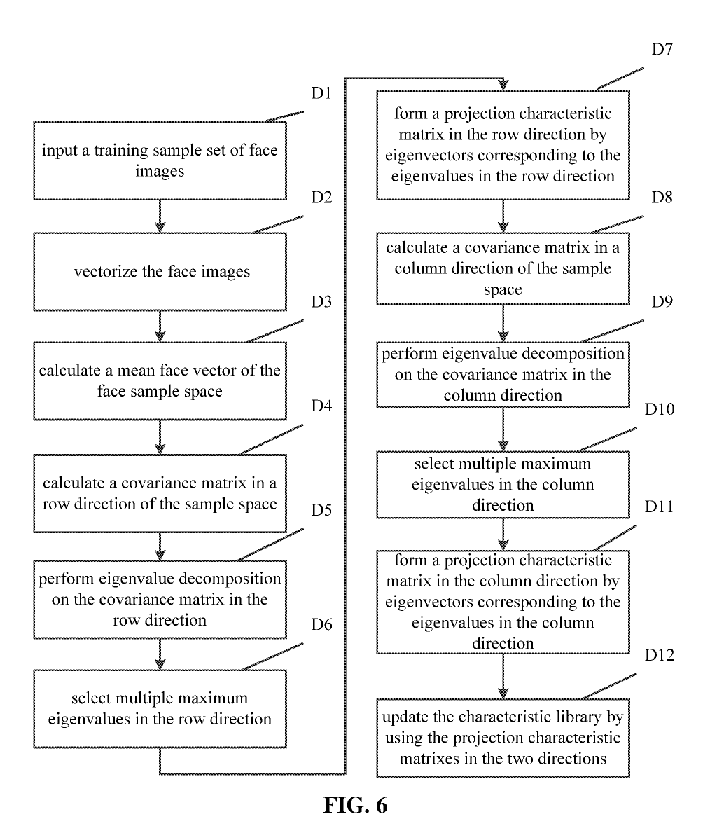

4. Reference is made to FIG. 6, which is a schematic flow chart of face sample space training. When a new face image is to be added to a face characteristic library, the sub-process of sample space training may be performed, to generate a new characteristic projection matrix and update the face characteristic library.

In step D1, a training sample set of face images is input.

In step D2, the face images are vectorized.

The above steps D1 to D2 are a stage of image pre-processing, which may specifically include: vectorizing a new added face image to convert the two-dimensional face image with a size of m×n to a column vector with a dimension of m×n. Finally, the new added face image and original face images in a characteristic library constitute N face vectors x₁, x₂, . . . , x_{N}.

In step D3, a mean face vector of the face sample space is calculated.

The step may specifically include: calculating a mean vector of all faces in the sample space:

$$\overline{x} = \frac{1}{N} {\sum }_{i = 1}^{N} {x}_{i}$$

In step D4, a covariance matrix in a row direction of the sample space is calculated.

The step may include: calculating the covariance matrix in the row direction of the sample space based on the following formula:

$$C = \frac{1}{N} {\sum }_{i = 1}^{N} {( {x}_{i} - \overline{x} )}^{T} ( {x}_{i} - \overline{x} )$$

In step D5, eigenvalue decomposition is performed on the covariance matrix in the row direction.

In step D6, multiple maximum eigenvalues in the row direction are selected.

The above two steps may specifically include: performing eigenvalue decomposition on the covariance matrix C in the row direction, and selecting the d maximum eigenvalues from all the n eigenvalues, where it is ensured that a sum of the d eigenvalues is greater than 95% of a sum of all the n eigenvalues.

In step D7, a projection characteristic matrix in the row direction is formed by eigenvectors corresponding to the multiple eigenvalues in the row direction.

The step may specifically include: forming the projection characteristic matrix Z in the row direction with the d eigenvectors corresponding to the d eigenvalues.

In step D8, a covariance matrix in a column direction of the sample space is calculated.

The step may include: calculating the covariance matrix in the column direction of the sample space based on the following formula:

$${C}_{T} = \frac{1}{N} {\sum }_{i = 1}^{N} ( {x}_{i} - \overline{x} ) {( {x}_{i} - \overline{x} )}^{T}$$

In step D9, eigenvalue decomposition is performed on the covariance matrix in the column direction.

In step D10, multiple maximum eigenvalues in the column direction are selected.

In step D11, a projection characteristic matrix in the column direction is formed by eigenvectors corresponding to the multiple eigenvalues in the column direction.

The above steps D9 to D11 are similar to steps D5 to D7, and are used to calculate the projection characteristic matrix X in the column direction.

In step D12, the characteristic library is updated by using the projection characteristic matrixes in the two directions.

The step specifically includes: updating the characteristic database by using the projection characteristic matrix Z in the row direction and the projection characteristic matrix X in the column direction.

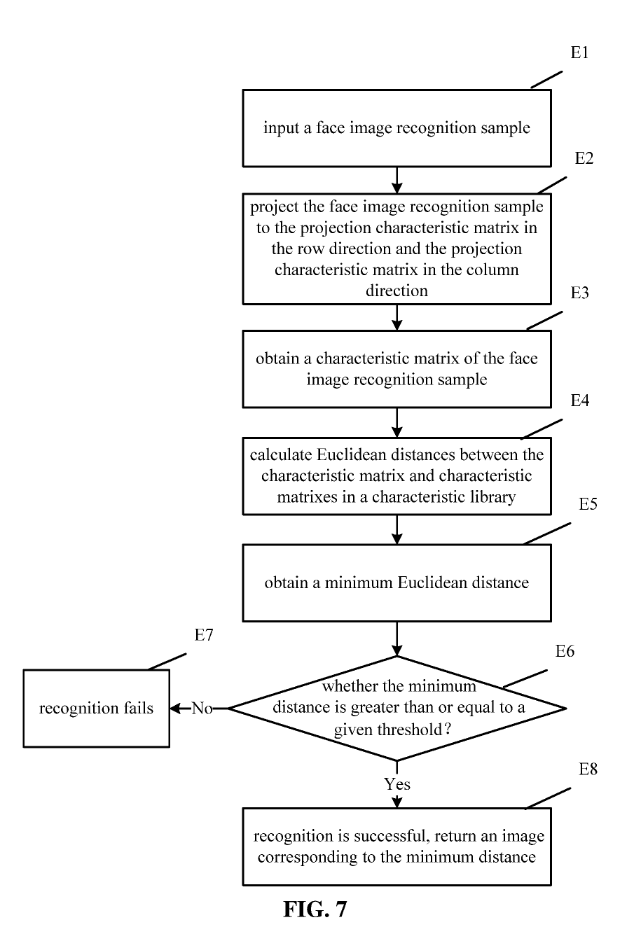

5. Reference is made to FIG. 7, which is a flow chart of face recognition (sample test). The sub-process specifically includes the following steps.

In step E1, a face image recognition sample is input.

In step E2, the face image recognition sample is projected to the projection characteristic matrix in the row direction and the projection characteristic matrix in the column direction.

In step E3, a characteristic matrix of the face image recognition sample is obtained.

The above steps E1 to E3 includes: inputting an image to be recognized, and projecting the image to be recognized to the projection characteristic matrix X and the projection characteristic matrix Z in conjunction with the two matrix obtained by means of two-dimensional principal component analysis in the row direction and the column direction, to obtain a characteristic matrix with dimension reduction in the row direction and the column direction: C′=Z^{T}AX, where A is a matrix representing the face image sample.

In step E4, Euclidean distances between the characteristic matrix and characteristic matrixes in a characteristic library are calculated.

In step E5, a minimum Euclidean distance is obtained.

The above steps E4 to E5 includes: calculating the Euclidean distances between the characteristic matrix and all the characteristic matrixes in the characteristic library, and obtaining an image Gₘᵢₙ corresponding to the minimum distance dₘᵢₙ.

In step E6, it is determined whether the minimum distance is greater than or equal to a given threshold. If the minimum distance is greater than or equal to the given threshold, the process goes to step E8. Otherwise, the process goes to step E7.

In step E7, information indicating that recognition fails is returned.

In step E8, information indicating that recognition is successful is returned, and an image corresponding to the minimum distance is returned.

The above steps E6 to E8 includes: determining whether the minimum distance is greater than or equal to the given threshold, and completing recognition and returning the corresponding image if the minimum distance is greater than or equal to the given threshold; and returning the information indicating that recognition fails if the minimum distance is less than the given threshold.

6. Reference is made to FIG. 8, which is a flow chart of two-dimensional code detection. The process includes the following steps.

In step F1, binarization processing based on maximum variance threshold is performed.

Gray scale image binarization processing is performed on a two-dimensional code image with an OTSU maximum variance threshold method.

In step F2, median filtering noise reduction is performed.

In a median filtering method, a pixel value is replaced with a median of gray scales of its neighboring pixels, to eliminate noise introduced in the process for capturing images.

In step F3, Canny operator (a multi-level edge detection algorithm) edge enhancement and detection is performed.

Comprehensive processing and enhancement is performed on edge of the two-dimensional code with a Max-Min difference method and a Canny edge extraction operator.

In step F4, locating based on filtered projection is performed.

Irregular and isolated noise is filtered with a projection method. A candidate target region is reserved as much as possible. A candidate location of the two-dimensional code is determined preliminarily.

In step F5, locating and correcting based on polynomial curves is performed.

A specific polynomial curves is selected to fit each distortion line in two dimensions. A correction function is obtained, and then image correction is achieved with the correction function.

7. Reference is made to FIG. 9, which is a flow chart of two-dimensional code recognition. Two-dimensional code information recognition uses RS error correction decoding recognition algorithm based on BM iterative algorithm. The process includes the following steps.

In step G1, adjoint polynomials are calculated.

In step G2, coefficients of error location polynomials are solved with a BM iterative algorithm, and polynomial locations are constructed.

The above steps G1 to G2 may specifically include: calculating data adjoint polynomials based on captured two-dimensional code image data with a Berlekamp-Massey algorithm, solving the coefficients of the error location polynomials by means of iteration, and constructing location coordinate data.

In step G3, roots of the error location polynomials are calculated with a FORNEY algorithm.

In step G4, it is determined whether an error exists. If an error exists, the process goes to step G5. Otherwise, the process goes to step G7.

The above steps G3 to G4 may specifically include: calculating the roots of error location coordinate polynomials with the FORNEY algorithm, performing recognition error correction determination based on the obtained values, and outputting the two-dimensional code information if there is no error. Otherwise, the process goes to step G5.

In step G5, error values and error locations are displayed.

In step G6, it is determined whether the error is beyond an error correction range. If the error is beyond the error correction range, the process goes to step G8. Otherwise, the process goes to step G9.

In step G7, decoding and outputting are performed.

In step G8, partial decoding, error correcting and outputting are performed.

In step G9, error correcting, decoding, and outputting are performed.

The above step G5 to G9 specifically includes: displaying the error values based on error correction recognition information, and performing decoding error correction threshold determination, and outputting information obtained from the two-dimensional code recognition after error codes are corrected based on a Reed-Solomon algorithm of linear block codes.

In the implementation solutions in the embodiments of the present disclosure, the two-dimension code and face recognition are combined to achieve synchronous identity authentication, which is more efficient and secure as compared with the conventional method for identity authentication. The method for identity authentication according to the embodiments of the present disclosure are not just capable of being applied to WeChat mobile payment and PC client login, that is, it is not limited to being applied to a certain application. The technology can also be widely applied to various fields such as attendance recording and access control system, since two-dimensional codes have been widely applied to mobile terminals.

In addition, the embodiments of the present disclosure are based on a function of dual camera simultaneous photography. A front camera is used to perform face recognition to capture face characteristic data at the same time as a rear camera scans a two-dimensional code. Generally, face characteristic data information is used as data for identity authentication. The two-dimensional code specifies an application or a program sub-module for accepting an identity authentication result.

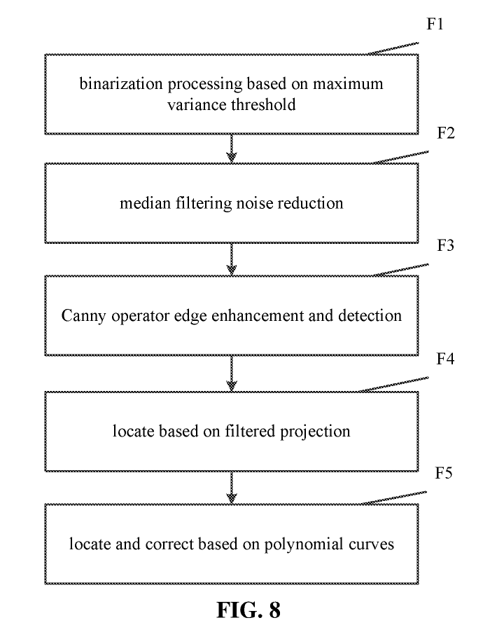

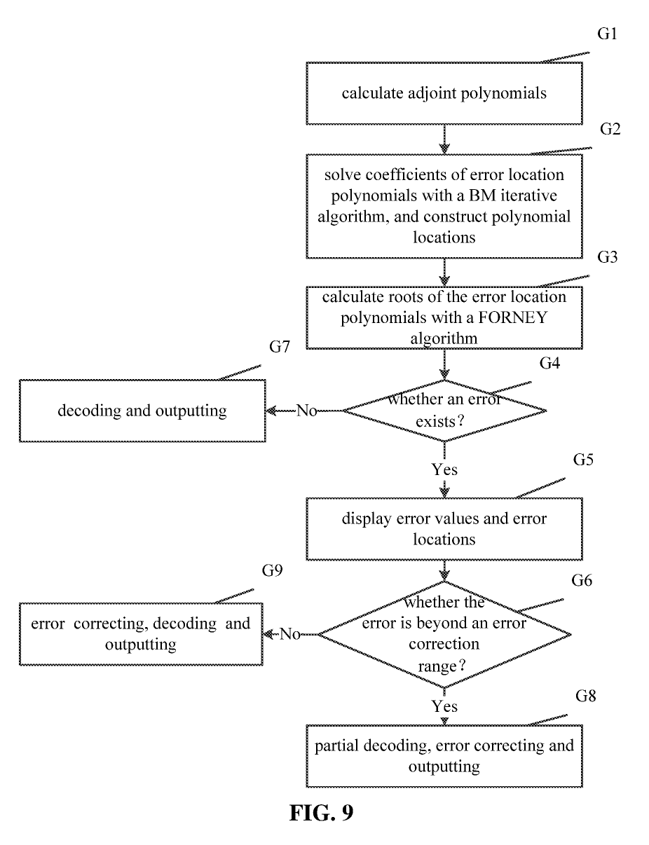

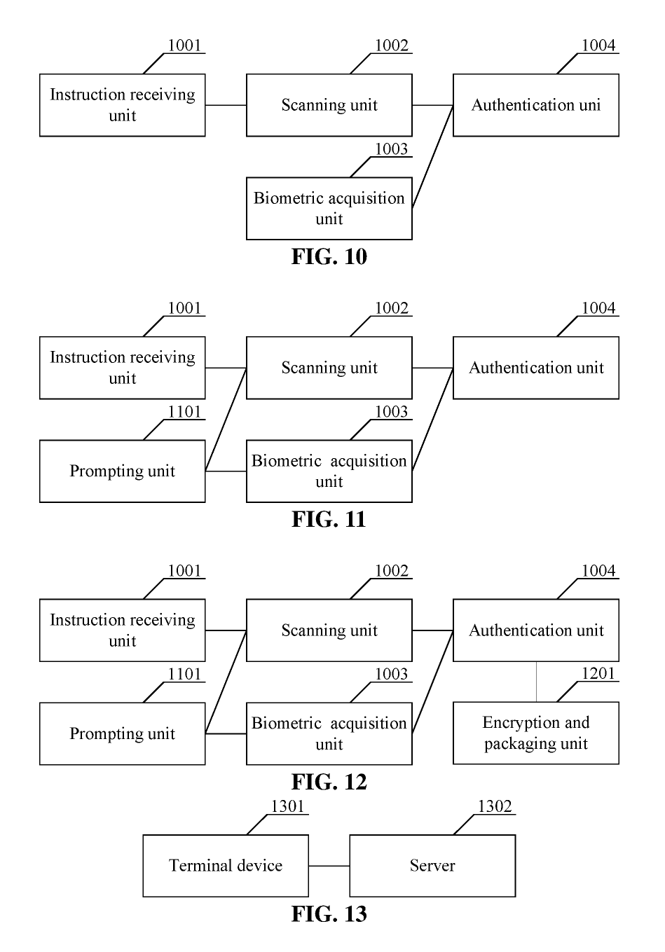

A terminal device is further provided according to an embodiment of the present disclosure. As shown in FIG. 10, the terminal device includes:

an instruction receiving unit 1001, configured to receive a two-dimensional code scanning instruction;

a scanning unit 1002, configured to scan a two-dimensional code, after the two-dimension scanning instruction is received by the instruction receiving unit 1001;

a biometric acquisition unit 1003, configured to open a biometric information acquisition function automatically to acquire biometric information of a user being operating the terminal device, after the two-dimensional code scanning instruction is received by the instruction receiving unit 1001; and

an authentication unit 1004, configured to perform identity authentication on the biometric information to determine whether the user has an operation authority corresponding to the two-dimensional code.

In the embodiment of the present disclosure, the two-dimensional code scanning instruction refers to a trigger condition for triggering the execution of two-dimensional code scanning, which is input by a user. For example, when using an application in the terminal device, if it is required to perform two-dimensional code scanning, the user may input a two-dimensional code scanning instruction. The two-dimensional code may be a picture in the terminal device or the two-dimensional code may be printed or displayed on medium other than the terminal device, which is not limited by the embodiments of the present disclosure. If the two-dimensional code is in the terminal device, two-dimensional code scanning may be achieved by scanning software. If the two-dimensional code is printed or displayed on medium other than the terminal device, the two-dimensional code may usually be scanned by using an application to control a rear camera of the terminal device.

In the embodiment of the present disclosure, the biometric information is used to authenticate the identity of the user. Specifically, the biometric information can be used to uniquely identify user identity and may include face, fingerprint, iris, voice and the like, alone or in combination. The biometric information acquisition function is opened automatically and is performed at the same time as the operation of scanning the two-dimensional code, thus the biometric information of the user currently being operating the terminal device can be obtained. That is, information that can be used to authenticate the user identity can be obtained automatically.

In the embodiment of the present disclosure, the terminal device executes the two-dimensional code scanning instruction to obtain the two-dimensional code after receiving the two-dimensional code scanning instruction; the two-dimensional code may include various operating instructions and may require authentication; in this case, the terminal device opens the biometric information acquisition function automatically to acquire the biometric information of the user currently being operating the terminal device, that is, the terminal device may automatically obtain information which can be used to authenticate user identity. In this way, a step of inputting information such as a verification code or a password is saved for the user. Therefore, a one-touch operation can be achieved, which simplify operation of identity authentication and improves the efficiency of identity authentication. In addition, since user identity authentication is performed by acquiring the biometric information of the user currently being operating the terminal device, the security of identity authentication is improved.

Optionally, in the embodiment of the present disclosure, the step of identity authentication may be locally completed in the terminal device directly. Or, the terminal device may be used as an acquisition device for information, and the step of identity authentication is completed at a side of a server. In a case that identity authentication is completed by the server, an identity authentication result may be fed back to the terminal device; or the identity authentication result is not fed back to the terminal device, and an operation result is returned to the terminal device after an operating instruction corresponding to the two-dimensional code is executed. Operations to be performed after an authentication result is determined may be arbitrarily set based on specific application scenarios and needs, which are not limited by the embodiments of the present disclosure. Specifically, in a case that identity authentication is to be locally completed in the terminal device, the authentication unit 1004 is configured to perform identity authentication on the biometric information based on locally stored biometric information, to determine whether the user has the operation authority corresponding to the two-dimensional code; or, in a case that identity authentication is to be completed at the side of the server, the authentication unit 1004 is configured to transmit the two-dimensional code obtained by scanning and the biometric information to the server, to enable the server to perform identity authentication on the biometric information to determine whether the user has the operation authority corresponding to the two-dimensional code.

It may be unsuccessful in scanning the two-dimensional code, and it may be unsuccessful in acquiring the biometric information, too. It can be understood that prompting is needed when it is unsuccessful in scanning the two-dimensional code. The step of acquiring the biometric information does not require the user to execute the two-dimensional code scanning instruction. In practice, since the biometric information needs to be used to perform identity authentication, prompting is also needed when it is unsuccessful in acquiring the biometric information. And the information needs to be acquired for the next time. Specifically: furthermore, as shown in FIG. 11, the terminal device further includes: a prompting unit 1101, configured to: if the scanning unit 1002 fails to scan the two-dimensional code, or the biometric acquisition unit 1003 fails to acquire the biometric information of the user currently being operating the terminal device, prompt that information is acquired unsuccessfully, and prompt that two-dimensional code information and the biometric information need to be re-acquired.

The two-dimensional code information and the biometric information need to be transmitted over network, the biometric information relates to privacy information of the user, and hence high security is needed. In order to improve information security, the two-dimensional code information and the biometric information may be encrypted according to the embodiment of the present disclosure. Specifically: furthermore, as shown in FIG. 12, the terminal device further includes: an encryption and packaging unit 1201, configured to: before the authentication unit 1004 transmits the two-dimensional code obtained by scanning and the biometric information to the server, package the two-dimensional code obtained by scanning and the biometric information into an encrypted message.

There are multiple types of biometric information that can be used to identify user identity, and implementations of the embodiments of the present disclosure will not be affected by the selection. At present, face recognition technology, iris recognition technology and fingerprint recognition technology are commonly used and have low cost. These technology can be implemented based on the current available hardware devices, and can be used as preferred implementation solutions of the embodiment of the present disclosure, which are specifically described as follows.

Optionally, the biometric information includes: face image information or iris information. The biometric acquisition unit 1003 is configured to: while the scanning unit 1002 scans the two-dimensional code, turn on a front camera of the terminal device automatically to obtain face image information or iris information in front of the terminal device.

The above embodiment may be applied to a terminal including a front camera, such as a mobile phone including a front camera and a rear camera. The front camera captures a face image at the same time as the rear camera captures a two-dimensional code, which is very convenient and efficient.

Optionally, the biometric information includes fingerprint information. The biometric acquisition unit 1003 is configured to: turn on a fingerprint sensor automatically, to capture a fingerprint at an interface button for inputting the two-dimensional code scanning instruction.

Some terminal devices have a fingerprint recognition function and also include a fingerprint sensor for capturing fingerprint information For example, for an attendance device, a fingerprint may be captured at a button where the user inputs a two-dimensional code scanning instruction. In this way, a one-touch operation can also be achieved, which is very convenient and efficient.

A system for identity authentication is further provided according to an embodiment of the present disclosure. As shown in FIG. 13, the system includes: a terminal device 1301 and a server 1302 which are communicatively connected with each other.

The terminal device 1301 is a terminal device 1301 according to the embodiments of the present disclosure, and the terminal device 1301 transmits a two-dimensional code and biometric information to the server 1302.

The server 1302 is configured to perform identity authentication on the biometric information to determine whether a user has an operation authority corresponding to the two-dimensional code.

In the embodiment of the present disclosure, the terminal device executes the two-dimensional code scanning instruction to obtain the two-dimensional code after receiving the two-dimensional code scanning instruction; the two-dimensional code may include various operating instructions and may require authentication; in this case, the terminal device opens the biometric information acquisition function automatically to acquire the biometric information of the user currently being operating the terminal device, that is, the terminal device may automatically obtain information which can be used to authenticate user identity. In this way, a step of inputting information such as a verification code or a password is saved for the user. Therefore, a one-touch operation can be achieved, which simplify operation of identity authentication and improves the efficiency of identity authentication.

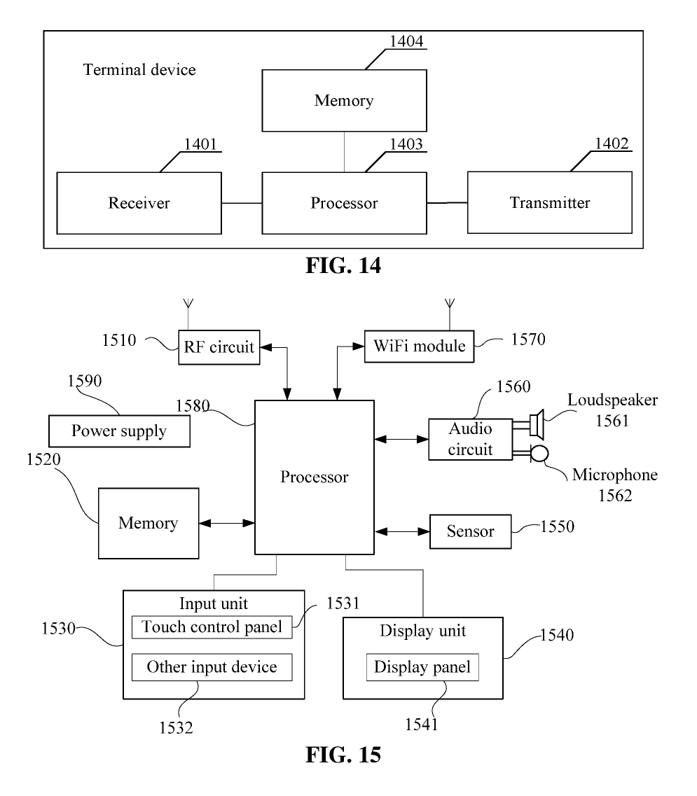

As shown in FIG. 14, another terminal device is further provided according to an embodiment of the present disclosure. As shown in FIG. 14, the terminal device includes: a receiver 1401, a transmitter 102, a processor 1403 and a memory 1404.

The processor 1403 is configured to control: scanning a two-dimensional code, after receiving a two-dimensional code scanning instruction; opening a biometric information acquisition function automatically to acquire biometric information of a user currently being operating the terminal device, after receiving the two-dimensional code scanning instruction; and performing identity authentication on the biometric information to determine whether the user has an operation authority corresponding to the two-dimensional code.

In the embodiment of the present disclosure, the two-dimensional code scanning instruction refers to a trigger condition for triggering the execution of two-dimensional code scanning, which is input by a user. For example, when using an application in the terminal device, if it is required to perform two-dimensional code scanning, the user may input a two-dimensional code scanning instruction. The two-dimensional code may be a picture in the terminal device or the two-dimensional code may be printed or displayed on medium other than the terminal device, which is not limited by the embodiments of the present disclosure. If the two-dimensional code is in the terminal device, two-dimensional code scanning may be achieved by scanning software. If the two-dimensional code is printed or displayed on medium other than the terminal device, the two-dimensional code may usually be scanned by using an application to control a rear camera of the terminal device.

In the embodiment of the present disclosure, the biometric information is used to authenticate the identity of the user. Specifically, the biometric information can be used to uniquely identify user identity and may include face, fingerprint, iris, voice and the like, alone or in combination. The biometric information acquisition function is opened automatically and is performed at the same time as the operation of scanning the two-dimensional code, thus the biometric information of the user currently being operating the terminal device can be acquired. That is, information that can be used to authenticate the user identity can be obtained automatically.

In the embodiment of the present disclosure, the terminal device executes the two-dimensional code scanning instruction to obtain the two-dimensional code after receiving the two-dimensional code scanning instruction; the two-dimensional code may include various operating instructions and may require authentication; in this case, the terminal device opens the biometric information acquisition function automatically to acquire the biometric information of the user currently being operating the terminal device, that is, the terminal device may automatically obtain information which can be used to authenticate user identity. In this way, a step of inputting information such as a verification code or a password is saved for the user. Therefore, a one-touch operation can be achieved, which simplify operation of identity authentication and improves the efficiency of identity authentication. In addition, since user identity authentication is performed by acquiring the biometric information of the user currently being operating the terminal device, the security of identity authentication is improved.

Optionally, in the embodiment of the present disclosure, the step of identity authentication may be locally completed in the terminal device directly. Or, the terminal device may be used as an acquisition device for information, and the step of identity authentication is completed at a side of a server. In a case that identity authentication is completed by the server, an identity authentication result may be fed back to the terminal device; or the identity authentication result is not fed back to the terminal device, and an operation result is returned to the terminal device after an operating instruction corresponding to the two-dimensional code is executed. Operations to be performed after an authentication result is determined may be arbitrarily set based on specific application scenarios and needs, which are not limited by the embodiments of the present disclosure. Specifically, the processor 1403 is configured to control: performing identity authentication on the biometric information to determine whether the user has the operation authority corresponding to the two-dimensional code includes: in a case that identity authentication is to be locally completed in the terminal device, performing identity authentication on the biometric information based on locally stored biometric information, to determine whether the user has the operation authority corresponding to the two-dimensional code; or, in a case that identity authentication is to be completed at the side of the server, transmitting the two-dimensional code obtained by scanning and the biometric information to the server, to enable the server to perform identity authentication on the biometric information to determine whether the user has the operation authority corresponding to the two-dimensional code.

It may be unsuccessful in scanning the two-dimensional code, and it may be unsuccessful in acquiring the biometric information, too. It can be understood that prompting is needed when it is unsuccessful in scanning the two-dimensional code. The step of acquiring the biometric information does not require the user to execute the two-dimensional code scanning instruction. In practice, since the biometric information needs to be used to perform identity authentication, prompting is also needed when it is unsuccessful in acquiring the biometric information. And the information needs to be acquired for the next time. Specifically, if it is unsuccessful in scanning the two-dimensional code, or it is unsuccessful in acquiring the biometric information of the user currently operating the terminal device, then the processor 1403 is further configured to control: prompting that information is acquired unsuccessfully, and prompting that two-dimensional code information and the biometric information need to be re-acquired.

The two-dimensional code information and the biometric information need to be transmitted over network, the biometric information relates to privacy information of the user, and hence high security is needed. In order to improve information security, the two-dimensional code information and the biometric information may be encrypted according to the embodiment of the present disclosure. Specifically, before transmitting the two-dimensional code obtained by scanning and the biometric information to the server, the processor 1403 is further configured to control: packaging the two-dimensional code obtained by scanning and the biometric information into an encrypted message.

There are multiple types of biometric information that can be used to identify user identity, and implementations of the embodiments of the present disclosure will not be affected by the selection. At present, face recognition technology, iris recognition technology and fingerprint recognition technology are commonly used and have low cost. These technology can be implemented based on the current available hardware devices, and can be used as preferred implementation solutions of the embodiment of the present disclosure, which are specifically described as follows.

If the biometric information includes: face image information or iris information, the processor 1403 is configured to control: while scanning the two-dimensional code, turning on a front camera of the terminal device automatically to obtain face image information or iris information in front of the terminal device.

The above embodiment may be applied to a terminal including a front camera, such as a mobile phone including a front camera and a rear camera. The front camera captures a face image at the same time as the rear camera captures a two-dimensional code, which is very convenient and efficient.

If the biometric information includes: fingerprint information, the processor 1403 is configured to control: turning on a fingerprint sensor automatically, to capture a fingerprint at an interface button for inputting the two-dimensional code scanning instruction.

Some terminal devices have a fingerprint recognition function and also include a fingerprint sensor for capturing fingerprint information For example, for an attendance device, a fingerprint may be captured at a button where the user inputs a two-dimensional code scanning instruction. In this way, a one-touch operation can also be achieved, which is very convenient and efficient.

As shown in FIG. 15, another terminal device is further provided according to an embodiment of the present disclosure. In order to facilitate illustration, only parts related to the embodiments of the present disclosure are illustrated, and for the technical details, please refer to the methods in the embodiments of the present disclosure. The terminal device may be any terminal device such as a mobile phone, a tablet computer, a personal digital assistant (PDA), a point of sales (POS) and a vehicle-carried computer. A case in which the terminal is a mobile phone is taken as an example.

FIG. 15 is a block diagram showing partial structure of a mobile phone which is related to a terminal provided according to an embodiment of the present disclosure. Referring to FIG. 15, the mobile phone includes: a radio frequency (RF) circuit 1510, a memory 1520, an input unit 1530, a display unit 1540, a sensor 1550, an audio circuit 1560, a wireless fidelity (WiFi) module 1570, a processor 1580, a power supply 1590 and so on. Those skilled in the art can understand that the structure of the mobile phone illustrated in FIG. 15 does not limit to the mobile phone. The technical solution according to the present disclosure may include more or less components than those shown in FIG. 15, or have some components combined, or use a different arrangement of the components.

In conjunction with FIG. 15, each of components of the mobile phone is described in detail.

The RF circuit 1510 may be configured to receive and send information, or to receive and send signals in a call. Specifically, the RF circuit delivers the downlink information received from a base station to the processor 1580 for processing, and transmits designed uplink data to the base station. Generally, the RF circuit 1510 includes but not limited to an antenna, at least one amplifier, a transceiver, a coupler, a low noise amplifier (LNA), and a duplexer. In addition, the RF circuit 1510 may communicate with other devices and network via wireless communication. The wireless communication may use any communication standard or protocol, including but not limited to Global System of Mobile communication (GSM), General Packet Radio Service (GPRS), Code Division Multiple Access (CDMA), Wideband Code Division Multiple Access (WCDMA), Long Term Evolution (LTE), E-mail, and Short Messaging Service (SMS).

The memory 1520 may be configured to store software programs and modules, and the processor 1580 may execute various function applications and data processing of the mobile phone by running the software programs and modules stored in the memory 1520. The memory 1520 may mainly include a program storage area and a data storage area. The program storage area may be used to store, for example, an operating system and an application required by at least one function (for example, a voice playing function, an image playing function). The data storage area may be used to store, for example, data established according to the use of the mobile phone (for example, audio data, telephone book). In addition, the memory 1520 may include a high-speed random access memory and a nonvolatile memory, such as at least one magnetic disk memory, a flash memory, or other volatile solid-state memory.

The input unit 1530 may be configured to receive input numeric or character information, and to generate a key signal input related to user setting and function control of the mobile phone. Specifically, the input unit 1530 may include a touch control panel 1531 and other input device 1532. The touch control panel 1531 is also referred to as a touch screen which may collect a touch operation thereon or thereby (for example, an operation on or around the touch control panel 1531 that is made by a user with a finger, a touch pen and any other suitable object or accessory), and drive corresponding connection devices according to a pre-set procedure. Optionally, the touch control panel 1531 may include a touch detection device and a touch controller. The touch detection device detects touch orientation of a user, detects a signal generated by the touch operation, and transmits the signal to the touch controller. The touch controller receives touch information from the touch detection device, converts the touch information into touch coordinates and transmits the touch coordinates to the processor 1580. The touch controller also can receive a command from the processor 1580 and execute the command. In addition, the touch control panel 1531 may be implemented by, for example, a resistive panel, a capacitive panel, an infrared panel and a surface acoustic wave panel. In addition to the touch control panel 1531, the input unit 1530 may also include other input device 1532. Specifically, the other input device 1532 may include but not limited to one or more of a physical keyboard, a function key (such as a volume control button, a switch button), a trackball, a mouse and a joystick.

The display unit 1540 may be configured to display information input by a user or information provided for the user and various menus of the mobile phone. The display unit 1540 may include a display panel 1541. Optionally, the display panel 1541 may be formed in a form of a Liquid Crystal Display (LCD), an Organic Light-Emitting Diode (OLED) or the like. In addition, the display panel 1541 may be covered by the touch control panel 1531. When the touch control panel 1531 detects a touch operation thereon or thereby, the touch control panel 1531 transmits the touch operation to the processor 1580 to determine the type of the touch event, and then the processor 1580 provides a corresponding visual output on the display panel 1541 according to the type of the touch event. Although the touch control panel 1531 and the display panel 1541 implement the input and output functions of the mobile phone as two separate components in FIG. 15, the touch control panel 1531 and the display panel 1541 may be integrated together to implement the input and output functions of the mobile phone in other embodiment.

The mobile phone may further include at least one sensor 1550, such as an optical sensor, a motion sensor and other sensors. The optical sensor may include an ambient light sensor and a proximity sensor. The ambient light sensor may adjust the luminance of the display panel 1541 according to the intensity of ambient light, and the proximity sensor may close the backlight or the display panel 1541 when the mobile phone is approaching to the ear. As a kind of motion sensor, a gravity acceleration sensor may detect the magnitude of acceleration in multiple directions (usually three-axis directions) and detect the value and direction of the gravity when the sensor is in the stationary state. The acceleration sensor may be applied in, for example, an application of mobile phone pose recognition (for example, switching between landscape and portrait, a correlated game, magnetometer pose calibration), a function about vibration recognition (for example, a pedometer, knocking). Other sensors such as a gyroscope, a barometer, a hygrometer, a thermometer, an infrared sensor, which may be further provided in the mobile phone, are not described herein.

The audio circuit 1560, a loudspeaker 1561 and a microphone 1562 may provide an audio interface between the user and the mobile phone. The audio circuit 1560 may transmit an electric signal, converted from received audio data, to the loudspeaker 1561, and a voice signal is converted from the electric signal and then outputted by the loudspeaker 1561. The microphone 1562 converts captured voice signal into an electric signal, the electric signal is received by the audio circuit 1560 and converted into audio data. The audio data is outputted to the processor 1580 for processing and then sent to another mobile phone via the RF circuit 1510; or the audio data is outputted to the memory 1520 for further processing.

WiFi is a short-range wireless transmission technique. The mobile phone may help the user to, for example, send and receive E-mail, browse a webpage and access a streaming media via the WiFi module 1570, and provide wireless broadband Internet access for the user. Although the WiFi module 1570 is shown in FIG. 15, it can be understood that the WiFi module 1570 is not necessary for the mobile phone, and may be omitted as needed within the scope of the essence of the disclosure.

The processor 1580 is a control center of the mobile phone, which connects various parts of the mobile phone by using various interfaces and wires, and implements various functions and data processing of the mobile phone by running or executing the software programs and/or modules stored in the memory 1520 and invoking data stored in the memory 1520, thereby monitoring the mobile phone as a whole. Optionally, the processor 1580 may include one or more processing cores. Preferably, an application processor and a modem processor may be integrated into the processor 1580. The application processor is mainly used to process, for example, an operating system, a user interface and an application. The modem processor is mainly used to process wireless communication. It can be understood that, the above modem processor may not be integrated into the processor 1580.

The mobile phone also includes the power supply 1590 (such as a battery) for powering various components. Preferably, the power supply may be logically connected with the processor 1580 via a power management system, therefore, functions such as charging, discharging and power management are implemented by the power management system.

Although not shown, the mobile phone may also include a camera, a Bluetooth module and so on, which are not described herein.

In the embodiment of the present disclosure, the processor 1580 included in the terminal further have the following functions.

The processor 1580 is configured to control: scanning a two-dimensional code, after receiving a two-dimensional code scanning instruction; opening a biometric information acquisition function automatically to acquire biometric information of a user currently being operating the terminal device, after receiving the two-dimensional code scanning instruction; and performing identity authentication on the biometric information to determine whether the user has an operation authority corresponding to the two-dimensional code.

In the embodiment of the present disclosure, the two-dimensional code scanning instruction refers to a trigger condition for triggering the execution of two-dimensional code scanning, which is input by a user. For example, when using an application in the terminal device, if it is required to perform two-dimensional code scanning, the user may input a two-dimensional code scanning instruction. The two-dimensional code may be a picture in the terminal device or the two-dimensional code may be printed or displayed on medium other than the terminal device, which is not limited by the embodiments of the present disclosure. If the two-dimensional code is in the terminal device, two-dimensional code scanning may be achieved by scanning software. If the two-dimensional code is printed or displayed on medium other than the terminal device, the two-dimensional code may usually be scanned by using an application to control a rear camera of the terminal device.

In the embodiment of the present disclosure, the biometric information is used to authenticate the identity of the user. Specifically, the biometric information can be used to uniquely identify user identity and may include face, fingerprint, iris, voice and the like, alone or in combination. The biometric information acquisition function is opened automatically and is performed at the same time as the operation of scanning the two-dimensional code, thus the biometric information of the user currently being operating the terminal device can be acquired. That is, information that can be used to authenticate the user identity can be obtained automatically.

In the embodiment of the present disclosure, the terminal device executes the two-dimensional code scanning instruction to obtain the two-dimensional code after receiving the two-dimensional code scanning instruction; the two-dimensional code may include various operating instructions and may require authentication; in this case, the terminal device opens the biometric information acquisition function automatically to acquire the biometric information of the user currently being operating the terminal device, that is, the terminal device may automatically obtain information which can be used to authenticate user identity. In this way, a step of inputting information such as a verification code or a password is saved for the user. Therefore, a one-touch operation can be achieved, which simplify operation of identity authentication and improves the efficiency of identity authentication. In addition, since user identity authentication is performed by acquiring the biometric information of the user currently being operating the terminal device, the security of identity authentication is improved.

Optionally, in the embodiment of the present disclosure, the step of identity authentication may be locally completed in the terminal device directly. Or, the terminal device may be used as an acquisition device for information, and the step of identity authentication is completed at a side of a server. In a case that identity authentication is completed by the server, an identity authentication result may be fed back to the terminal device; or the identity authentication result is not fed back to the terminal device, and an operation result is returned to the terminal device after an operating instruction corresponding to the two-dimensional code is executed. Operations to be performed after an authentication result is determined may be arbitrarily set based on specific application scenarios and needs, which are not limited by the embodiments of the present disclosure. Specifically, the processor 1580 is configured to control: performing identity authentication on the biometric information to determine whether the user has the operation authority corresponding to the two-dimensional code includes: in a case that identity authentication is to be locally completed in the terminal device, performing identity authentication on the biometric information based on locally stored biometric information, to determine whether the user has the operation authority corresponding to the two-dimensional code; or, in a case that identity authentication is to be completed at the side of the server, transmitting the two-dimensional code obtained by scanning and the biometric information to the server, to enable the server to perform identity authentication on the biometric information to determine whether the user has the operation authority corresponding to the two-dimensional code.

It may be unsuccessful in scanning the two-dimensional code, and it may be unsuccessful in acquiring the biometric information, too. It can be understood that prompting is needed when it is unsuccessful in scanning the two-dimensional code. The step of acquiring the biometric information does not require the user to execute the two-dimensional code scanning instruction. In practice, since the biometric information needs to be used to perform identity authentication, prompting is also needed when it is unsuccessful in acquiring the biometric information. And the information needs to be acquired for the next time. Specifically, if it is unsuccessful in scanning the two-dimensional code, or it is unsuccessful in acquiring the biometric information of the user currently operating the terminal device, then the processor 1580 is further configured to control: prompting that information is acquired unsuccessfully, and prompting that two-dimensional code information and the biometric information need to be re-acquired.

The two-dimensional code information and the biometric information need to be transmitted over network, the biometric information relates to privacy information of the user, and hence high security is needed. In order to improve information security, the two-dimensional code information and the biometric information may be encrypted according to the embodiment of the present disclosure. Specifically, before transmitting the two-dimensional code obtained by scanning and the biometric information to the server, the processor 1580 is further configured to control: packaging the two-dimensional code obtained by scanning and the biometric information into an encrypted message.

There are multiple types of biometric information that can be used to identify user identity, and implementations of the embodiments of the present disclosure will not be affected by the selection. At present, face recognition technology, iris recognition technology and fingerprint recognition technology are commonly used and have low cost. These technology can be implemented based on the current available hardware devices, and can be used as preferred implementation solutions of the embodiment of the present disclosure, which are specifically described as follows.

If the biometric information includes: face image information or iris information, the processor 1580 is configured to control: while scanning the two-dimensional code, turning on a front camera of the terminal device automatically to obtain face image information or iris information in front of the terminal device.

The above embodiment may be applied to a terminal including a front camera, such as a mobile phone including a front camera and a rear camera. The front camera captures a face image at the same time as the rear camera captures a two-dimensional code, which is very convenient and efficient.

If the biometric information includes: fingerprint information, the processor 1580 is configured to control: turning on a fingerprint sensor automatically, to capture a fingerprint at an interface button for inputting the two-dimensional code scanning instruction.

Some terminal devices have a fingerprint recognition function and also include a fingerprint sensor for capturing fingerprint information For example, for an attendance device, a fingerprint may be captured at a button where the user inputs a two-dimensional code scanning instruction. In this way, a one-touch operation can also be achieved, which is very convenient and efficient.

It should be noted that, the units included in the embodiments of the terminal device are divided according to functional logics; and the division is not limited to the above approach, as long as corresponding functions can be realized. In addition, names of the functional units are used to distinguish among these units and do not limit the protection scope of the present disclosure.

In addition, those skilled in the art that can understand that all or some of the steps in the method embodiments may be implemented by related hardware instructed by a program. The program may be stored in a computer readable storage medium. The storage medium may be a read-only memory, a magnetic disk or an optical disk, and so on.

The above are only preferred embodiments of the present disclosure, and the protection scope of the present disclosure is not limited hereto. Changes and substitutions, made by those skilled in the art without any creative efforts within the technical scope disclosed by the embodiments of the present disclosure, fall within the protection scope of the present disclosure. Therefore, the protection scope of the present disclosure should be defined by the protection scope of the claims.

1. An identity authentication method, comprising:
receiving, by a terminal device, a two-dimensional code scanning instruction;
scanning, by the terminal device, a two-dimensional code, in response to the two-dimensional code scanning instruction;
opening, by the terminal device, a biometric information acquisition function to acquire biometric information of a user being operating the terminal device, in response to the two-dimensional code scanning instruction; and
performing identity authentication on the biometric information to determine whether the user has an operation authority corresponding to the two-dimensional code.

2. The method according to claim 1, wherein performing identity authentication on the biometric information to determine whether the user has the operation authority corresponding to the two-dimensional code comprises:
performing identity authentication on the biometric information based on locally stored biometric information, to determine whether the user has the operation authority corresponding to the two-dimensional code; or
transmitting the two-dimensional code obtained by scanning and the biometric information to a server, to enable the server to perform identity authentication on the biometric information to determine whether the user has the operation authority corresponding to the two-dimensional code.

3. The method according to claim 2, wherein before transmitting the two-dimensional code obtained by scanning and the biometric information to the server, the method further comprises:
packaging the two-dimensional code obtained by scanning and the biometric information into an encrypted message.

4. The method according to claim 1, wherein if it is unsuccessful in scanning the two-dimensional code, or it is unsuccessful in acquiring the biometric information of the user being operating the terminal device, the method further comprises:
prompting that information is not acquired successfully, and prompting that two-dimensional code information and the biometric information need to be re-acquired.

5. The method according to claim 1,
wherein the biometric information comprises face image information or iris information; and
wherein opening the biometric information acquisition function to acquire biometric information of the user being operating the terminal device comprises:
while scanning the two-dimensional code, turning on a front camera of the terminal device to obtain face image information or iris information in front of the terminal device.

6. The method according to claim 2,
wherein the biometric information comprises face image information or iris information; and
wherein opening the biometric information acquisition function to acquire biometric information of the user being operating the terminal device comprises:
while scanning the two-dimensional code, turning on a front camera of the terminal device to obtain face image information or iris information in front of the terminal device.

7. The method according to claim 3,
wherein the biometric information comprises face image information or iris information; and
wherein opening the biometric information acquisition function to acquire biometric information of the user being operating the terminal device comprises:
while scanning the two-dimensional code, turning on a front camera of the terminal device to obtain face image information or iris information in front of the terminal device.

8. The method according to claim 4,
wherein the biometric information comprises face image information or iris information; and
wherein opening the biometric information acquisition function to acquire biometric information of the user being operating the terminal device comprises:
while scanning the two-dimensional code, turning on a front camera of the terminal device to obtain face image information or iris information in front of the terminal device.

9. The method according to claim 1,
wherein the biometric information comprises fingerprint information; and
wherein opening the biometric information acquisition function to acquire biometric information of the user being operating the terminal device comprises:
turning on a fingerprint sensor, to capture a fingerprint at an interface button for inputting the two-dimensional code scanning instruction.

10. The method according to claim 2,
wherein the biometric information comprises fingerprint information; and
wherein opening the biometric information acquisition function to acquire biometric information of the user being operating the terminal device comprises:
turning on a fingerprint sensor, to capture a fingerprint at an interface button for inputting the two-dimensional code scanning instruction.

11. The method according to claim 3,
wherein the biometric information comprises fingerprint information; and
wherein opening the biometric information acquisition function to acquire biometric information of the user being operating the terminal device comprises:
turning on a fingerprint sensor, to capture a fingerprint at an interface button for inputting the two-dimensional code scanning instruction.

12. The method according to claim 4,
wherein the biometric information comprises fingerprint information; and
wherein opening the biometric information acquisition function to acquire biometric information of the user being operating the terminal device comprises:
turning on a fingerprint sensor, to capture a fingerprint at an interface button for inputting the two-dimensional code scanning instruction.

13. A terminal device, comprising:
a processor;
a memory; and
program units stored in the memory to be executed by the processor, wherein the program units comprise:
an instruction receiving unit, configured to receive a two-dimensional code scanning instruction;
a scanning unit, configured to scan a two-dimensional code, in response to the two-dimension scanning instruction;
a biometric acquisition unit, configured to open a biometric information acquisition function to acquire biometric information of a user being operating the terminal device, in response to the two-dimensional code scanning instruction; and
an authentication unit, configured to perform identity authentication on the biometric information to determine whether the user has an operation authority corresponding to the two-dimensional code.

14. The terminal device according to claim 13, wherein:
the authentication unit is configured to perform identity authentication on the biometric information based on locally stored biometric information, to determine whether the user has the operation authority corresponding to the two-dimensional code; or
the authentication unit is configured to transmit the two-dimensional code obtained by scanning and the biometric information to a server, to enable the server to perform identity authentication on the biometric information to determine whether the user has the operation authority corresponding to the two-dimensional code.

15. The terminal device according to claim 14, wherein the program units further comprise:
an encryption and packaging unit, configured to: before the authentication unit transmits the two-dimensional code obtained by scanning and the biometric information to the server, package the two-dimensional code obtained by scanning and the biometric information into an encrypted message.

16. The terminal device according to claim 13, wherein the program units further comprise:
a prompting unit, configured to: if the scanning unit fails to scan the two-dimensional code, or the biometric acquisition unit fails to acquire the biometric information of the user being operating the terminal device, prompt that information is not acquired successfully, and prompt that two-dimensional code information and the biometric information need to be re-acquired.

17. The terminal device according to claim 13,
wherein the biometric information comprises face image information or iris information; and
wherein the biometric acquisition unit is configured to: while the scanning unit scans the two-dimensional code, turn on a front camera of the terminal device to obtain face image information or iris information in front of the terminal device.

18. The terminal device according to claim 14,
wherein the biometric information comprises face image information or iris information; and
wherein the biometric acquisition unit is configured to: while the scanning unit scans the two-dimensional code, turn on a front camera of the terminal device to obtain face image information or iris information in front of the terminal device.

19. The terminal device according to claim 13,
wherein the biometric information comprises fingerprint information; and
wherein the biometric acquisition unit is configured to: turn on a fingerprint sensor, to capture a fingerprint at an interface button for inputting the two-dimensional code scanning instruction.

20. An identity authentication system, comprising a terminal device according to claim 13 and a server which are communicatively connected with each other,
wherein the terminal device configured to transmit a two-dimensional code and biometric information to the server; and
wherein the server is configured to perform identity authentication on the biometric information to determine whether a user has an operation authority corresponding to the two-dimensional code.
